(19) United States
(12) Patent Application Publication
(10) Pub. No.: US 2005/0163973 A1
(43) Pub. Date: Jul. 28, 2005

(54) Novelty Articles and Methods of Using Novelty Articles

(75) Inventors: Randy Scott Drinkward, Vista, CA (US); Rick Scott Drinkward, Vista, CA (US); Michael P. Eddy, Del Mar, CA (US)

Correspondence Address: LAW OFFICE OF MICHAEL P. EDDY, #510, 2683 VIA DE LA VALLE, SUITE G, DEL MAR, CA, 92014, US

(73) Assignees: Mr. Rick Scott Drinkward, Vista, CA (US); Mr. Randy Scott Drinkward, Vista, CA (US)

(21) Appl. No.: 10/908,185

(22) Filed: May 1, 2005

(51) Int. Cl. C08J 3/00; B32B 3/00

(52) U.S. Cl. 428/166

(57) ABSTRACT

A novelty article comprising a housing formed from a first side surface sealingly attached to a second side surface forming a cavity therebetween, a compound contained in the cavity, the cavity for releasing said liquid when mechanical pressure is applied to said article. Other embodiments include the compound being released through the second surface or the first surface. Another embodiment includes an adhesive for attaching said article to a user on the first surface. Another embodiment encompasses a method of providing an extruding illusory effect, the method comprising the steps of providing a novelty article comprising a housing formed from a first side surface sealingly attached to a second side surface forming a cavity therebetween, a compound contained in said cavity, the cavity for releasing said liquid when mechanical pressure is applied to said article, and squeezing the article so that the compound is extruded.

### BACKGROUND

The present invention relates generally to novelty, gag or amusement articles, and more particularly to costumes, costume masks and other novelty accessories that provide an illusory experience.

Prior art costume articles and masks have been constructed to provide various enhanced looks for the wearer. Typical costume masks have a decorative appearance, often having different colors, textures and shapes. These masks may also use foils, sequins, fluorescent paints, and other accessories to enhance their visual appearance, and many are made of resilient materials such as plastic, rubber, latex or resin material molded to form a hollow head shape, with the hollow head shape body adapted to cover the wear's face. For example, the mask disclosed in U.S. Pat. No. 5,970,522 fits over the face of a person and employs an inflatable sack that causes a feature of the mask, such as the eyeball, to protrude. U.S. Pat. No. 5,787,508 discloses yet another decorative mask that is inflated to create a three dimensional mask. U.S. Pat. No. 6,093,475 describes a mask with a flowing liquid to enhance the mask. While the liquid in this example is colored to simulate blood, it is contained in the mask and not extruded.

### SUMMARY

Embodiments of the claimed subject matter include a novelty article comprising a housing formed from a first side surface sealingly attached to a second side surface forming a cavity therebetween, a compound contained in the cavity, the cavity for releasing said liquid when mechanical pressure is applied to said article. Another embodiment includes the compound being released through the second surface. Another embodiment includes the compound being released through the first surface. Yet another embodiment includes an adhesive for attaching said article to a user on the first surface.

Another embodiment of the claimed subject matter encompasses a method of providing an extruding illusory effect, the method comprising the steps of providing a novelty article comprising a housing formed from a first side surface sealingly attached to a second side surface forming a cavity therebetween, a compound contained in said cavity, the cavity for releasing said liquid when mechanical pressure is applied to said article, and squeezing the article so that the compound is extruded.

### BRIEF DESCRIPTION OF THE DRAWINGS

FIG. 1 is a partial cross sectional view of an embodiment of the claimed subject matter having a filled cavity;

FIG. 2 is a partial cross sectional view of an embodiment of the claimed subject matter having an unfilled cavity;

FIG. 3 is a perspective view of an embodiment of the claimed subject matter;

FIG. 4 is a partial cross sectional underside view of an embodiment of the claimed subject matter with a plug and having a cavity filled with a capsule;

FIG. 5 is a partial cross sectional underside view of an embodiment of the claimed subject matter with a plug removed and having an unfilled cavity;

FIG. 6A is a bottom view of an embodiment of the claimed subject matter showing the plug 24;

FIG. 6B is a side view of an embodiment of the claimed subject matter showing the plug 24;

FIG. 7 is a perspective view of multiple embodiments of the claimed subject matter;

FIG. 8 is a perspective view of some embodiments of the claimed subject matter;

FIG. 9 is a cross sectional view of another embodiment of the claimed subject matter;

FIG. 10 is a cross sectional view of another embodiment of the claimed subject matter having capsules containing the compound 12;

FIG. 11 is a perspective view of a costume mask having multiple embodiments of the claimed subject matter;

FIG. 12 is a side cross sectional view of the costume mask of FIG. 11.

FIG. 13 is interior perspective view of the costume mask of FIG. 11.

FIG. 14 is a perspective view of several embodiments of the claimed subject matter shown as pimples and a lesion on a user's hand;

FIG. 15 is a perspective view of a lesion embodiment of the claimed subject matter shown on a user's hand; and

FIG. 16 is a perspective view of a lesion embodiment and of multiple pimple articles of the claimed subject matter shown on a user's foot.

### DETAILED DESCRIPTION OF THE EMBODIMENTS

List of References
10 Novelty article
12 Compound
14 Cavity
16 Housing
18 aperture (Always open or Rupturable)
22 Base
24 Plug
26 capsule
28 aperture on underside of housing
30 Costume mask
32 Patch Costume mask
34 Lesion embodiment
38 Glove article
40 Sock article

Embodiments of the claimed subject matter include a novelty article which, when squeezed, allows one or more compounds to be extruded providing an illusory or entertainment effect. The compound in the embodiment may include liquid, viscous liquid or any other substance that can be held in cavities. Upon squeezing with mechanical finger pressure, the compound is released through one or more outer surfaces of the article resulting in a novel effect.

Unless defined otherwise, all terms used herein have the same meaning as is commonly understood by one of skill in the art to which embodiments of the claimed subject matter belong. Thus, for purposes herein, a novelty article 10 refers to any inanimate article of manufacture that upon combination with an extrudable compound provides amusement, entertainment, recreation or enjoyment.

Addition of the extrudable compound to the novelty article of manufacture does not add to the function of the item, but adds entertainment, amusement or recreational aspects to the item so that the resulting combination is a novelty item. Any such inanimate object that is combined with one or more extrudable compounds is intended to be encompassed herein. As used herein, a compound refers to any mixture. It may be a solution, a suspension, liquid, powder, a paste, aqueous, non-aqueous or any combination thereof.

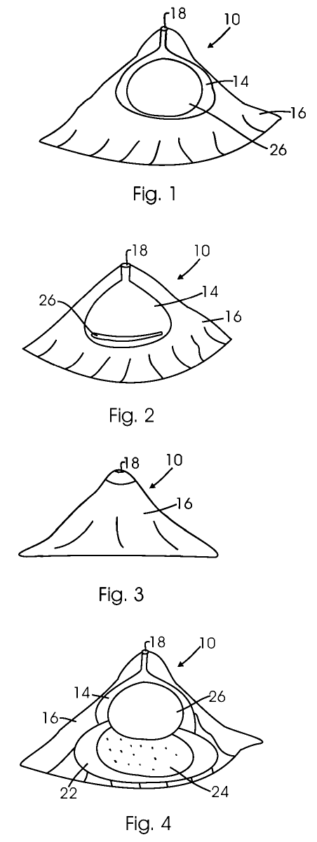

Referring now to the drawings, and with specific reference to FIGS. 1 through 3, a novelty article constructed in accordance with the teachings of the embodiments of the claimed subject matter is generally referred to by reference numeral 10. As shown therein, the novelty article 10 has the general appearance of a raised surface, pimple or bump which can be placed on a section of the user, such as the face. The article 10 may be fastened or accommodated on a portion of a user's body with an adhesive, such as a self adhesive backing. The article 10 includes an amount of compound 12 contained within cavity 14, so that during use of such an article 10, a user can crush or squeeze the housing 16 of article 10, forcing the compound 12 out aperture 18, and giving the effect of a liquid extruding from the user's body.

Referring now to FIG. 3, a side view of an article 10 in accordance with an embodiment of the claimed subject matter is illustrated. The article 10 includes a housing 16 having an open or a rupturable aperture 18 at the apex of article 10. In this embodiment, the article 10 is provided in the shape of a large pimple, but it is to be understood that the form of article 10 may be provided in any imaginable shape to create any desired type of appendage or other form. A mold may be made in various shapes and forms so it can be used to create a suitable housing 16 to form impressions of complementary shapes for article 10.

FIG. 5 illustrates an alternative embodiment wherein article 10 also in the shape of a pimple wherein a capsule (not shown) may be accommodated within cavity 14. FIG. 4 shows the same embodiment with capsule 26 placed inside cavity 14. This embodiment may also include a means for attaching the article 10 to the wearer such as a self adhesive strip on the underside of housing 16.

Article 10 may be manufactured from any suitable material, including but are not limited to, molded natural rubbers, artificial rubbers such as urethane and polyurethane, and the like, latex, tennis ball material, canvas, vinyl, stuffed latex, stuffed plush material (i.e., stuffed with beads, Styrofoam, filler, or the like), fleece or other woolly material, or the like.

The exterior skin may be separately formed and added to housing 16 or it may be integral to housing 16. In an alternative embodiment, the housing 16 is punctured and squeezed to allow the compound 12 to be pushed or squeezed from the housing 16. In one embodiment, article 10 may be injection molded from natural rubber. Additionally, the inner surface portion of housing 16 and the outer surface portion of cavity 14 may be formed as one integral unit of article 10.

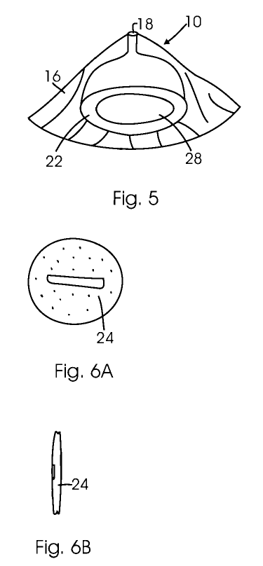

FIG. 6A. is a perspective view of the outwardly facing surface of plug 24 and FIG. 6B is a side view of plug 24. As shown in FIGS. 6A and 6B, the plug 24 is removable to allow compound 12 to be filled into cavity 14. Cavity 14 may be filled with a quantity of compound 12 or it may be filled with a disposable or refillable capsule 26 containing compound 12.

Plug 24 may be threaded on one side facing the cavity 14, so as to facilitate the removal and replacement of cover 24. In this way, plug 24 can be removably secured to housing 16. Housing 16 has a complementary threaded opening located on the underside of article 10. As illustrated in FIG. 6A, the outwardly facing side of cover 24 may be engaged and turned using a small coin so that cover 24 unscrews off the rear of housing 16 exposing cavity 14. Once cavity 14 is refilled with compound 12, cover 24 can be re-secured to the threaded opening of housing 16. Plus 24 may also be unthreaded so that it is securable with pressure or other suitable means. As mentioned previously, cavity 14 may be refilled using a disposable capsule 26 or a refillable capsule 26.

Housing 16 may be made of one layer or of multiple layers and it may be constructed of materials such as rubber, latex or the like. Alternative structures and methods of forming the structures of housings 16 and the structures surrounding cavities 14 may also be employed. For example, the housing 16 may be composed of a clear or translucent material, such as polyethylene or polypropylene, which permits viewing of the compound 12 before its extrusion. The materials may be made from a glow-in-the dark elastomeric material such that the surface of article 10 will glow in the dark.

An optional base 22 may be positioned below cavity 14 to support the expulsion of compound 12. Base 22 may be made of a rubber, plastic (polyethylene,) a dense foam, or any other suitable support material which could provide support to the housing 16 or the contents of housing 16.

In another embodiment not illustrated, a three layer article may be constructed of the semi-rigid base 22 and the cavity 14 with a flexible layer placed therebetween. The flexible layer may be sandwiched between base 22 and a cavity 14 wherein the squeezing of either layer would cause the flexible layer to cause fluid transfer, yet the flexible layer remains protected by the semi-rigid shells. The squeezing of a layer may be the result of manually applied pressure or differential air pressure between the layers.

The novelty article 10 may be applied to the user's skin with a suitable adhesive, for example as a self adhesive strip that is fastened to any outer surface of housing 16, such as the underside of housing 16. The adhesive used may be a water soluble non-toxic setting adhesive such as, for example and not by way of limitation, polymers, gelatin, glucose, fructose, animal glue, glycerine, agar or processed seaweed, guargum, non toxic white glue and the like suitable adhesives or combination thereof.

The aperture 18, shown at the apex of article 10 in FIGS. 1 through 3, may be breakable by the user/wearer or by another person or by a device. When used with a breakable capsule 26, such as a paintball capsule, the aperture 18 may be always open. Embodiments having a rupturable aperture 18 may be self sealing when the cavity 14 is extinguished and the compound 12 has ceased flowing out of aperture 18. Other embodiments may not have an aperture 18. In these cases, an area of weakened resistance may be provided in housing 16, for instance with a joining line of the housing 16, to causing the housing 16 to burst open when pressure is applied to the housing 16. Housing 16 can also be constructed so that when pressure is applied to article 10, housing 16 will burst at one or more predetermined points.

As used herein, a combination refers to any association between two or among more items, and as used herein, fluid refers to any composition that can flow. Fluids that may be used as compound 12 thus encompass compositions that are in the form of semi-solids, pastes, solutions, aqueous mixtures, waxes, gels, lotions, creams and other such compositions. Food or non-toxic coloring or dyes may be added to the compound 12 which itself may be edible. The article 10 may be stored in colder temperature environments to preserve the compound 12, such as when the article 10 is filled with ice cream.

The compound 12 may be provided in the form of a gel-like substance such as soft fondant creme, but not limited to, which is marketed by the Hershey Foods Corporation and found in that company's creme Easter eggs under the name brand Cadbury. The compound 12 may be comprised of a non-toxic gel or gel-like substance. Embodiment may have compound 12 composed of a transparent, solid or translucent inorganic or organic substance that can be used to provide a suitable illusory effect. An example is a disappearing ink. The compound 12 may be colorless or odorless or it may have and it may contain other substances such as preservatives.

For example, any suitable amount of compound 12 may be used. For example, a small amount such as 1 ml may be used or a large amount such as one gallon may be used. The size of article 10 will also be sized accordingly.

Illustrative, albeit non-limiting examples of compound 12 are wax, paper pulp, sawdust, lint, straw, thread, twine, leaves, and other non toxic, ecologically friendly materials or combinations thereof suitable for the purpose intended. Any solid such as that derived from a thixotropic component may be used as the compound 12. A “thixotropic composition” is known as an admixture which behaves as a pseudo fluid when force is applied to it, but has properties of a solid when at rest. Other materials with varying viscosities, such as but not limited to gelatin, pudding, oatmeal, and toothpaste, could be used as the compound 12. Furthermore, a dye or fluorescent additive may be added to the compound 12 to enhance the visual aspect of the compound 12. Alternately, fluid compound 12 may be made of a glow-in-the dark material so that the extruded fluid will glow in the dark. In another example, a green fluid compound 12 may be used to simulate phlem, and a red compound 12 could provide a make-believe human blood appearance.

When more than one compound 12 is used in an embodiment, the components of compounds 12 may be combined or kept physically separated prior to extrusion by a variety of means. For example, embodiments of article 10 may be made in an edible version, with compound 12 formed of such materials as a red colored food material such as a red cornstarch material, or the like. In such an embodiment, the article 10 may be used as a novelty and extruded compound 12 may be used as a consumable treat. This may include the use of flavored or scented additives to compound 12.

The fluids of compound 12 may also be visible through transparent or translucent outer shell of article 10. For example, a red color for compound 12 could be seen through housing 16 and interpreted as blood. After the liquid flows out of aperture 18, it can also be collected for further use as well as disposed of. In the case of an edible compound 12, it can be eaten by the user for further illusionary effect. It is to be understood that other materials, liquids and compounds can be used as the compound 12.

One or more ampoules or vesicles containing one or more compounds 12 may be sealed within the cavity 14. The compound 12 may also be stored in more than one cavity 14 and the compounds 12 being stored in the different cavities 14 may also be different from one another. The cavity 14 may contain compound 12 in a liquid or gel-like form or it may contain a reusable or disposable capsule or module, such as a paintball capsule. The capsule or compound may be pressurized to give added effect when extruded allowing the compound 12 to be extruded in a projectile fashion.

Once the cavity 14 is loaded with compound 12, a user can then manually depress or crush the article 10 inwardly with sufficient force to cause the housing 16 to exert pressure on the cavity 14 and propel the compound 12 out the aperture 18. In this way, when the article 10 is crushed, the aperture 18 is ruptured thereby allowing the liquid held in the interior cavity 14 to be splattered outwardly through aperture 18 or where there is no aperture 18 provided on housing 16, compound 12 may be extruded through the housing 16.

The cavity 14 may also be constructed to consist of a series of passageways which extend throughout the article or articles. Cavity locations may also be located in separate housings 16 or more than one cavity 14 may share a common housing 16. Moreover, it should be noted that while the article 10 is described as having one or more cavities 14 that are primarily designed to accommodate one or more fluids, the cavity 14 may take on other shapes and be made up of more than one sub-cavity without departing from the spirit and scope of the embodiments of the claimed subject matter. For example, a multi-sided surface such as a tetrahedron, triangle or the like may be used. Other shapes and suitable alternatives that would be apparent to those skilled in the art may be used without departing from the spirit and scope of the claimed subject matter.

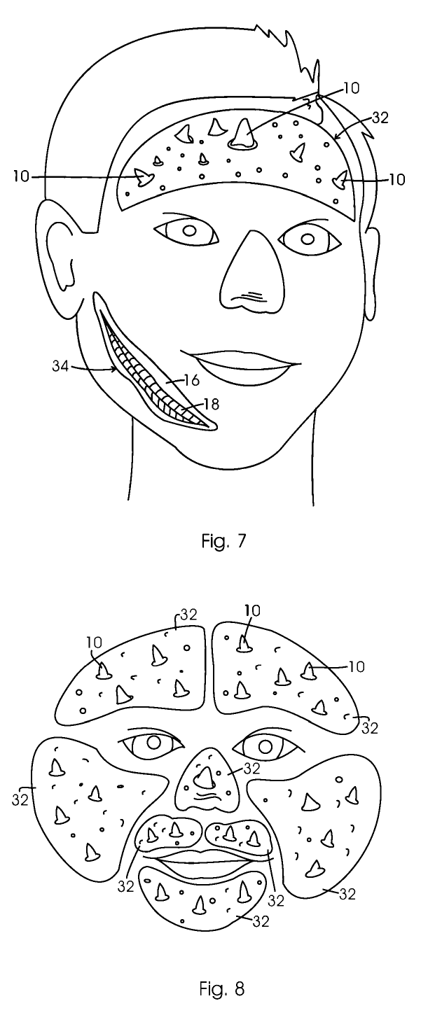

Housings 16 may be formed into lesion like articles from molds and impressions of molds using modeling substances such as latex, and these impressions contain one or more of the articles 10 which are filled with compound 12. Lesions are illustrated in FIGS. 7, 15 and 16 and are generally designated by the numeral 34. The compound 12 may be squeezed out of multiple cavities 14 which act as passageways in the housing 16 and further to multiple apertures 18 spread over a suitable area so that the compound 12 flows or oozes out of the article providing a flowing appearance from housing 16 giving the illusory impression of an oozing lesion.

Other forms and shapes may take the form of a costume mask or a partial mask containing multiple articles 10. FIG. 7 is an illustration of an embodiment of the claimed subject matter having a partial mask 32 with multiple articles 10 as well as a lesion 34. FIG. 8. is another perspective view of multiple embodiments of the partial mask 32 placed together on the face of a wearer. The partial costume mask 32 incorporates a plurality of novelty articles 10 with a backing that is shaped to form portions of a human face or any other body structures such as tongue, bone, or body appendages. The backing may be made out of hard plastic or latex, or any other suitable material to provide support to the embodiment. In the illustrated embodiments, a plurality of articles 10 in the shapes of burstable pimples are accommodated on various locations of a partial masks 32 which are constructed out of a flexible material and which includes a fastening arrangement for securement to the face of the user.

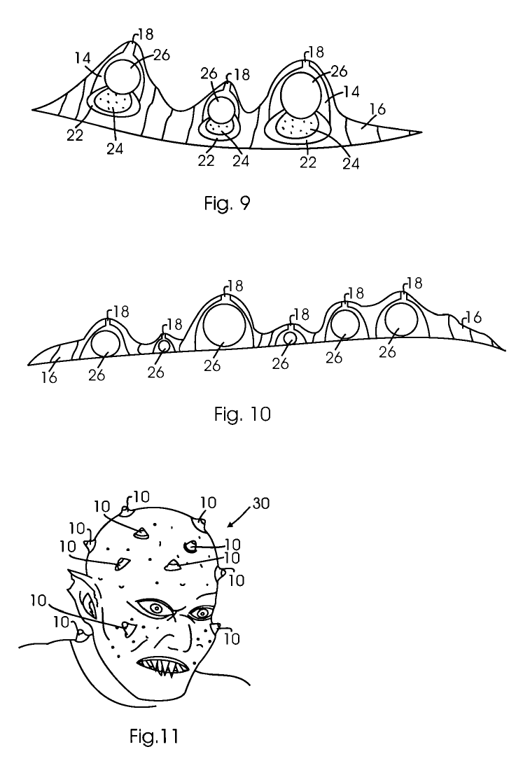

FIG. 9 is a cross sectional view of a partial mask 32 illustrating the base 22, plug 24, capsule 26, cavity 14 and aperture 18. Cavity 14 may contain a refillable capsule 26 or a quantity of compound 12. FIG. 10 is a cross sectional view of another embodiment illustrating a partial mask 32 having cavities 14 containing the compound 12 but no base 22 element.

FIG. 11 depicts a costume mask 30 that simulates a face accommodating a plurality of the novelty articles 10 used to release the liquid compounds 12 out of the surface of the mask 30. In this embodiment, a natural rubber or latex is used to provide a realistic skin-like appearance. The natural rubber may be provided in any number of skin tones to match a user's skin. Other outer skin surfaces of embodiments of mask 30 may be shaped, textured, and colored to look like a human, alien like, zombie like, or animal face, or any other body part or appendage.

The costume mask 30 or a partial mask 32 may be attached to a human head by the use of any suitable means, such as adhesives and hook and loop (VELCRO) straps. A complete mask 30 may also cover the wearer's head and not include a securing means. Portions of the mask 30 may include different embodiments of the novelty article to simulate extrusion of other types of fluids. For example, the chin of mask 30 may contain fluid giving the illusion of a zit and the cheek may contain a different shaped article to give the illusion of an oozing lesion 34. The result is a mask that can extrude various types of compounds 12 for different effects.

Alternatively the articles 10 such as those shown on FIGS. 1 through 5 may be placed in strategic points such as the forehead, the cheek area, and lips of the user. The costume mask 30 may also be constructed from a clear or transparent material so that the compound 12 is viewable before extrusion. The mask 30 or partial mask 32 accommodating one or more articles 10 can themselves be disposed of after use, or the individual cavities 14 of articles 10 may be refilled for multiple uses. The interior of mask 30, as shown in FIG. 13, may be formed of hard plastic and may have one or more removable covering plugs 24 so that the individual capsules 26 for each article 10 could be replaced after use. The plug 24 may also be used to directly refill the cavity 14 with the same or a different compound 12.

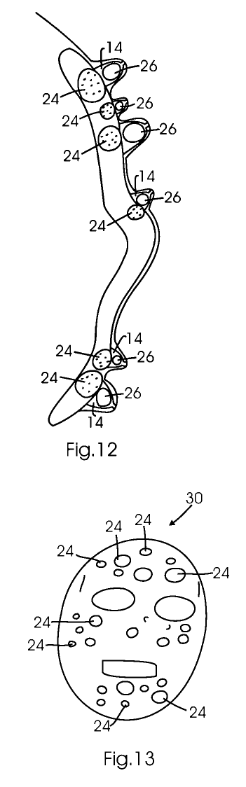

Referring now to FIG. 12, a cross sectional view of costume mask 30 is illustrated with a plug 24, cavity 14 and aperture 18. Costume mask 30 may also include or receive upper portions of the shoulders of the wearer. Such an arrangement may be desirable for certain applications to provide stability. The full and partial face masks can be constructed from a lightweight moldable plastic material having a first side surface that is sealed to a second side surface forming a cavity 14 therebetween.

In order to cover at least the wearer's entire upper body and face, a full body costume containing one or more articles 10 may also be constructed. The articles 10 may also be made in the form of appendages or prosthesis, each having an extrudable compound 12. Similarly, simulated appendages or prosthesis may be constructed with one or more articles 10, each capable of extruding one or more compounds 12. The use of the described compounds, such as gel-like liquids, is for illustrative purposes only, and as previously mentioned, alternative substances could be utilized including solids or other materials.

In addition, embodiments may be used inside the mouth such as placed around the tongue or teeth to provide a humorous effect. Similarly, various embodiments may be used on lips to provide different effects. While embodiments illustrated herein are accommodated on a portion of a human body or on costume accessories, other embodiments could be used with any other suitable object or animal.

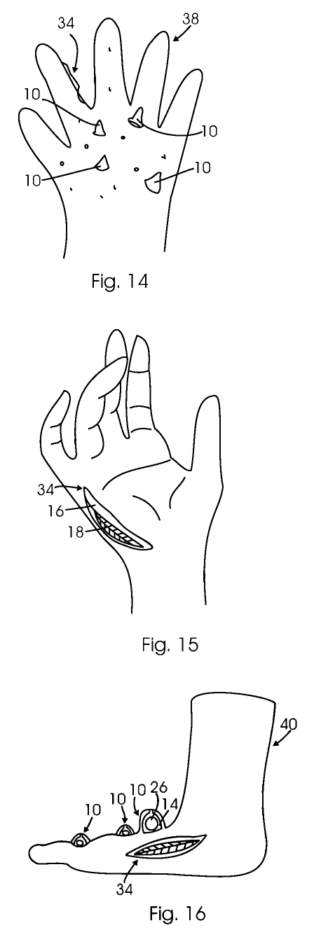

With reference to FIGS. 14 and 15, another embodiment in the form of a full or partial glove may be used on the hand of a user. These embodiments are illustrated and generally identified at reference numeral 38. Hand fitted glove embodiment 38 includes multiple articles 10, each with an extrudable compound 12 such a colored fluid that can be popped and extruded at different intervals for an amusement effect. Gloves 38 both include a lesion 34 with a housing 16 and with a plurality of apertures 18 for an oozing effect.

Referring now to FIG. 16, set forth is yet another embodiment wherein a sock shaped housing 40 is provided with a plurality of articles 10. The housing 40 is deformed by the wearer allowing the compound 12 to be extruded from the plurality of rupterable apertures 18.

In use, when the article 10 is squeezed, the article 10 will release a fluid compound given the appearance of bodily fluid being excreted though an opening in article 10 away from the wearer's body. Other forces created by intimate contact with the internal cavity 14, for example by flexing of the housing 16 can also cause the cavity 14 to rupture, thereby releasing the extrudable compound 12. In one embodiment, upon pressing the article 10, the article 10 extrudes a quantity of fluid compound 12 at an aperture 18 is provided at an apex of the housing 16. A crushing or squeezing process can be initiated by the user or by a third person.

In another embodiment, the compound 12 could be withdrawn from the cavity 14 through the use of a syringe or another similar device. In yet another embodiment, the housing 16 could be constructed so it could be accommodated around the arm in a sleeve or cuff fashion on the arm of a user wherein a syringe could be used to draw a quantity of compound 12 that has a blood like appearance giving the illusory effect of blood being drawn. In an another alternative embodiment, the compound 12 could be injected into the article 10 using a conventional syringe, motorized pump, or the like and the compound 12 could be automatically replaced after being extruded.

In other embodiments, the exterior skin of article 10 may be brightly colored and a gel-like compound 12 may be another color in order to provide a visual contrast to the user and observers. For example, if the article 10 is provided in the form of a pimple, a gel-like liquid may be used to simulate the bodily fluid of the user. In this embodiment, the housing 16 is attached at its underside to the skin of a user using a suitable adhesive, and upon crushing or rupturing of the exterior skin of the housing 16, the gel-like liquid compound 12 squirts out and splatters in much the same manner as a real pimple.

In use as a novelty, gag, practical joke, or amusement device, article 10 may be squeezed by the user to simulate popping of a zit generating amusement for spectators and the user alike by giving the illusion of extruding bodily fluids. An unsuspecting third party would be unaware of the novel nature of the article until he or she is surprised by the fluid flow emanating from the article. After use, the article 10 can then be washed or wiped down for subsequent use. The article 10 and any other surfaces, such as a mask 30, may be coated with a non-stick material to facilitate clean-up of compound 12.

The embodiments herein described are done so in detail for exemplary purposes only, and may be subject to many different variations in design, structure, application and operation methodology. Thus, while the preferred embodiment and various alternative embodiments of the invention have been disclosed and described in detail herein, these detailed embodiments should be interpreted in an illustrative, exemplary manner, and not in a limited sense. It will be apparent to those skilled in the art that various changes in form and detail may be made therein without departing from the spirit and scope thereof.

1. A novelty article comprising:
a housing formed from a first side surface sealingly attached to a second side surface forming a cavity therebetween,
a compound contained in said cavity;
said cavity for releasing said liquid when mechanical pressure is applied to said article.

2. A novelty article of claim 1, wherein said compound is released through the second surface.

3. A novelty article of claim 1, wherein said compound is released through the first surface.

4. A novelty article of claim 1, wherein said first surface includes an adhesive for attaching said article to a user.

5. The novelty article according to claim 1, further comprising a means for securing at least one of said side surfaces in a fixed position.

6. The novelty article according to claim 1, wherein said article is accommodated on the external surface of a costume mask.

7. The novelty article according to claim 1, wherein said article is affixed to the body of a user.

8. The novelty article according to claim 1, wherein said article is accommodated on the external surface of a body appendage covering.

9. The novelty article according to claim 8, wherein said body appendage is selected from the following group: cheek, chin, forehead, ear, eyebrow, lip, neck, temple, teeth, nose, head, tongue, torso, legs.

10. The novelty article according to claim 1 wherein said compound is propelled from said cavity through an aperture.

11. The novelty article according to claim 1, wherein said compound is propelled from said cavity through said first surface or said second surface.

12. The novelty article according to claim 1, further comprising a removable capsule accommodated within said cavity for accommodating said compound.

13. The novelty article according to claim 12, wherein said removable capsule is propelled from said article.

14. A novelty article according to claim 1, wherein the viscosity of said compounds is controlled to achieve desired fluidity.

15. A novelty article according to claim 1, wherein two or more compounds are used.

16. A novelty article according to claim 1, wherein two or more cavities are used.

17. A novelty article according to claim 1, wherein said compound is withdrawn from said cavity through the use of a syringe.

18. A novelty article according to claim 1, wherein said compound is edible.

19. A method of providing an extruding illusory effect, the method comprising the steps of:
providing a novelty article comprising:
a housing formed from a first side surface sealingly attached to a second side surface forming a cavity therebetween,
a compound contained in said cavity;
said cavity for releasing said liquid when mechanical pressure is applied to said article;
and squeezing said article so that said compound to be extruded.
